(19) United States
(12) Patent Application Publication
(10) Pub. No.: US 2019/0250767 A1
(43) Pub. Date: Aug. 15, 2019

(54) CAPACITIVE SENSING DEVICE AND METHOD FOR OBTAINING SAFETY REFERENCE POINT OF THE SAME

(71) Applicant: Shang-Li LEE, Keelung City (TW)

(72) Inventor: Shang-Li LEE, Keelung City (TW)

(21) Appl. No.: 16/267,731

(22) Filed: Feb. 5, 2019

(30) Foreign Application Priority Data
Feb. 14, 2018 (TW) 107105570

(51) Int. Cl. G06F 3/041; G06F 3/044

(52) U.S. Cl. CPC G06F 3/0418; G06F 3/044

(57) ABSTRACT

A method for obtaining a safety reference point of a capacitive sensing device is applicable to a capacitive sensing device. In the method, a signal simulation unit is used to generate a touch simulation signal simulating a touch and a touch sensing signal simulating a touch detection result that a touch event occurs for a signal sensor, then whether a measurement condition is proper is judged according to the touch simulation signal, an actually measured sensing signal, and the simulated touch detection result, and corresponding adjustment is performed properly, so as to improve accuracy and/or a recognition rate of the capacitive sensing device.

### CROSS-REFERENCE TO RELATED APPLICATION

This non-provisional application claims priority under 35 U.S.C. § 119(a) to Patent Application No. 107105570 in Taiwan, R.O.C. on Feb. 14, 2018, the entire contents of which are hereby incorporated by reference.

### BACKGROUND

### Technical Field

The present invention relates to a capacitive sensing technology, and in particular, to a capacitive sensing device and a method for obtaining a safety reference point of the same.

### Related Art

To improve use convenience, in increasing electronic devices, a touch screen is used as an operation interface, so that a user directly clicks a picture on the touch screen to perform an operation, thereby providing a more convenient and human-based operation mode. The touch screen is mainly formed by a display providing a display function and a sensing device providing a touch function.

Generally, the sensing device knows, by using a self-capacitance sensing technology and/or a mutual capacitance sensing technology, whether a panel is touched by the user. In a sensing process, when the sensing device detects a change in a capacitance value at a coordinate location, the sensing device judges that this coordinate location is touched by the user. Therefore, during operations, the sensing device stores a non-touch capacitance value for each coordinate location, and when subsequently receiving a most recent capacitance value, judges, by comparing the most recent capacitance value with the non-touch capacitance value, whether a location corresponding to this capacitance value is touched.

A measurement condition of the sensing device is an important factor of determining a sensing value. A measurement environment affects effects of a measurement result that include accuracy, a recognition rate and the like. The sensing device has a difficulty in that the measurement environment cannot be predicted, and therefore a manual correction process usually needs to be introduced, so as to obtain measurement consistency.

### SUMMARY

In view of the foregoing problem, a detection mechanism is needed to understand impact of a to-be-measured environment on a measurement value of a capacitive sensing device, and determine which safety reference point is used to perform measurement before a correct measurement value can be obtained.

In an embodiment, a method for obtaining a safety reference point of a capacitive sensing device includes: simulating, by a signal simulation unit, a touch detection result that a touch event occurs to generate a first touch sensing signal; performing, based on a safety reference point, touch detection on a signal sensor to generate a first background sensing signal; simulating, by the signal simulation unit, the touch event to generate a touch simulation signal; integrating the background sensing signal and the touch simulation signal to obtain a second touch sensing signal; comparing the first touch sensing signal with the second touch sensing signal to obtain a difference message; adjusting the safety reference point according to a difference amount when the difference message exceeds a threshold; and skipping adjusting the safety reference point when the difference message does not exceed the threshold.

In an embodiment, a capacitive sensing device includes: a signal sensor and a signal processing circuit. The signal sensor includes: a plurality of first electrodes and a plurality of second electrodes that are disposed in a staggered manner. The signal processing circuit is electrically connected to the signal sensor, and the signal processing circuit performs: generating a first touch sensing signal simulating a touch detection result that a touch event occurs for the signal sensor; performing, based on a safety reference point, touch detection on the signal sensor to generate a background sensing signal; generating a touch simulation signal simulating the touch event; integrating the background sensing signal and the touch simulation signal to obtain a second touch sensing signal; comparing the first touch sensing signal with the second touch sensing signal to obtain a difference message; adjusting the safety reference point according to a difference amount when the difference message exceeds a threshold; and skipping adjusting the safety reference point when the difference message does not exceed the threshold.

To sum up, in the capacitive sensing device and the method for obtaining a safety reference point of the same according to the present invention, a signal simulation unit (software or hardware) is used to directly simulate a sensing signal, and then whether a measurement condition (for example, safety reference point) is proper is judged according to the simulated sensing signal and an actually measured sensing signal, so as to appropriately perform corresponding adjustment, and then improve accuracy and/or a recognition rate of the capacitive sensing device.

### BRIEF DESCRIPTION OF THE DRAWINGS

The present invention will become more fully understood from the detailed description given herein below for illustration only, and thus are not limitative of the present invention, and wherein:

FIG. 1 is a schematic block diagram of a capacitive sensing device according to an embodiment of the present invention;

FIG. 2 is a schematic diagram of an embodiment of a signal sensor in FIG. 1;

FIG. 3 is a schematic diagram of related signals of a signal processing circuit according to an embodiment;

FIG. 4 is a schematic flowchart of a method for obtaining a safety reference point of a capacitive sensing device according to an embodiment of the present invention;

FIG. 5 is a schematic flowchart of an embodiment of step S11 in FIG. 4;

FIG. 6 is a schematic flowchart of a part of a method for obtaining a safety reference point of a capacitive sensing device according to another embodiment of the present invention;

FIG. 7 is a schematic diagram of an embodiment of a signal processing circuit in FIG. 1;

FIG. 8 is a schematic diagram of an exemplary example of a signal simulation unit in FIG. 1;

FIG. 9 is a schematic diagram of another exemplary example of a signal simulation unit in FIG. 1;

FIG. 10 is a schematic diagram of still another exemplary example of a signal simulation unit in FIG. 1; and

FIG. 11 is a schematic diagram of yet another exemplary example of a signal simulation unit in FIG. 1.

### DETAILED DESCRIPTION

First, a method for obtaining a safety reference point of a capacitive sensing device according to any embodiment of the present invention may be applicable to a capacitive sensing device, for example but not limited to, a touch panel, an electronic drawing board, or a handwriting tablet. In some embodiments, the capacitive sensing device and a display may be further integrated into a touch screen. Moreover, touch of the capacitive sensing device may occur by using a hand, a stylus pen, a touch drawing pen, or another touch element.

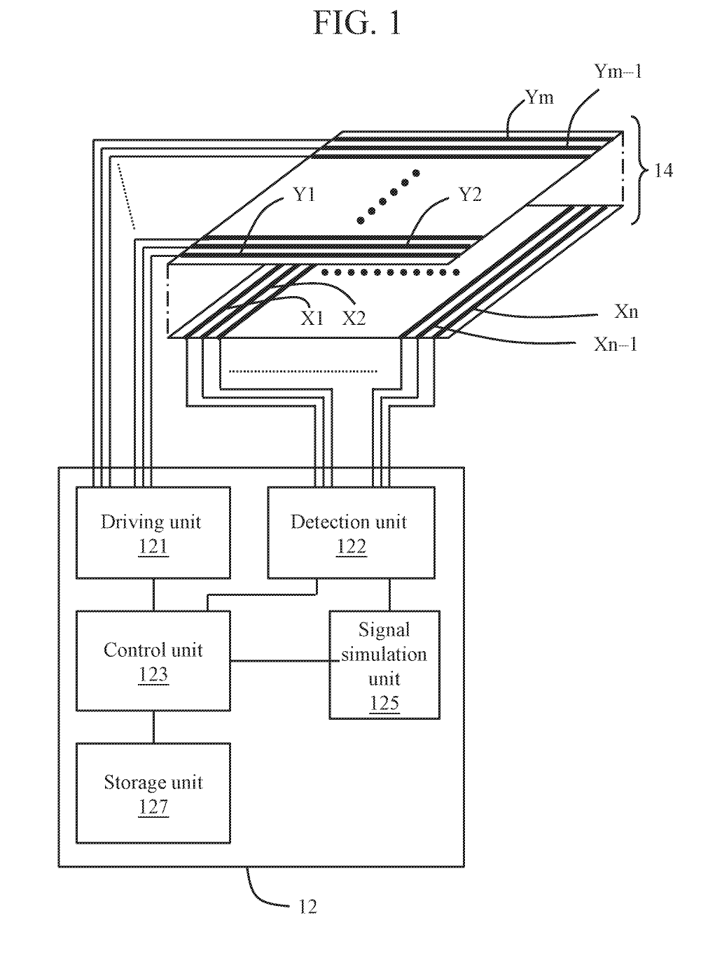

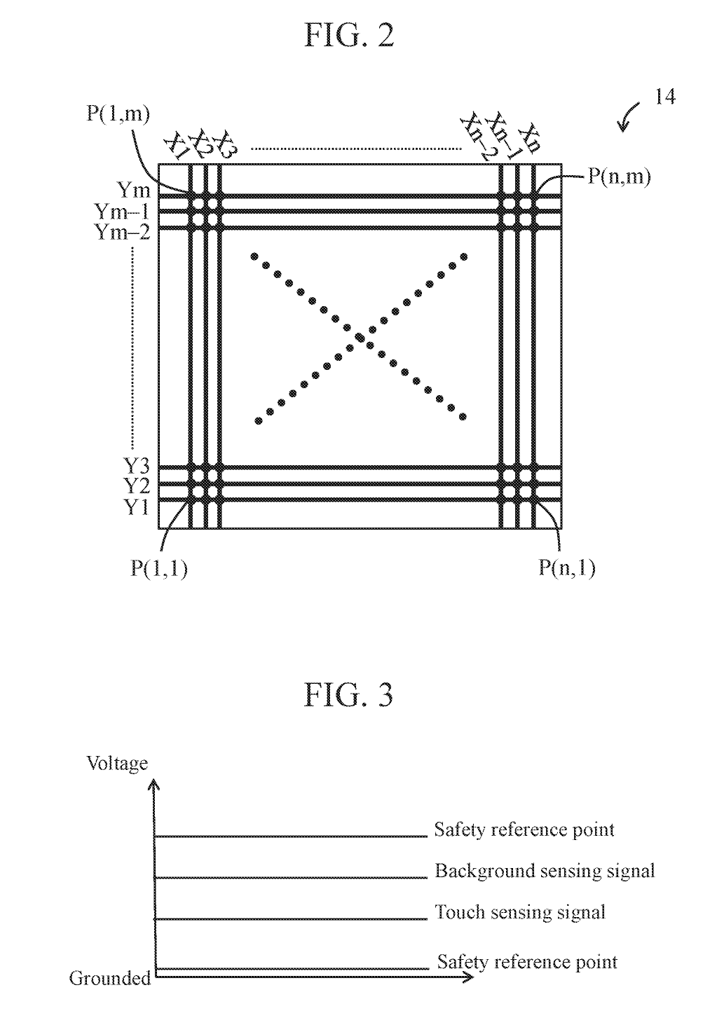

FIG. 1 is a schematic block diagram of a capacitive sensing device according to an embodiment of the present invention. FIG. 2 is a schematic diagram of an embodiment of a signal sensor in FIG. 1. Referring to FIG. 1 and FIG. 2, the capacitive sensing device includes a signal processing circuit 12 and a signal sensor 14. The signal sensor 14 is connected to the signal processing circuit 12.

the signal sensor 14 includes a plurality of electrodes (for example, first electrodes X1 to Xn and second electrodes Y1 to Ym) configured in a staggered manner. That is, the first electrode X1 to Xn cross the second electrode lines Y1 to Ym, where n and m are positive integers, and n may be equal to m, or may be not equal to m. Viewed from the top view, the first electrodes X1 to Xn and the second electrodes Y1 to Ym are staggered with each other, and define a plurality of sensing points P(1,1) to P(n,m) configured in a matrix, as shown in FIG. 2.

In some embodiments, viewed from the top view, the first electrodes X1 to Xn and the second electrodes Y1 to Ym that are staggered are in a rhombic honeycomb shape, a mesh shape or a grid shape. In some embodiments, the first electrodes X1 to Xn and the second electrodes Y1 to Ym may be located on different planes (located on different sensing layers), and an insulation layer (not shown) may be sandwiched between the different planes, but the present invention is not limited thereto. In some other embodiments, the first electrodes X1 to Xn and the second electrodes Y1 to Ym may be alternatively located on a same plane, that is, located on only a single sensing layer.

The signal processing circuit 12 includes a driving/detection unit and a control unit 123. The control unit 123 is coupled to the driving/detection unit. The driving/detection unit includes a driving unit 121 and a detection unit 122. Herein, depending on a current situation during design the driving unit 121 and the detection unit 122 may be integrated into a single element, or may be implemented by using two elements. The driving unit 121 is used to output a driving signal to the first electrodes X1 to Xn, and the detection unit 122 is used to measure the second electrodes Y1 to Ym based on a safety reference point to generate a measurement signal (background sensing signal or touch sensing signal) of each sensing point. Herein, the control unit 123 can be used to control operations of the driving unit 121 and the detection unit 122 and judge a capacitance value change of each sensing point according to the background sensing signal (a capacitance value at the time of determining that there is no touch) and the touch sensing signal (a capacitance value at the time of being about to detect whether a touch occurs). Herein, when it is measured that the capacitance value is changed to an extent, the control unit 123 may judge that the corresponding sensing point is touched and determine, based on a judgment result, whether a corresponding location signal is returned. A relationship among the safety reference point, the background signal and the sensing signal is shown in FIG. 3.

The signal processing circuit 12 may perform touch detection by using a self-capacitance detection technology or a mutual capacitance detection technology. Using the self-capacitance detection technology as an example, when touch detection is performed, after the driving unit 121 drives an electrode, the detection unit 122 may detect a self-capacitance value of the electrode, so as to detect a change in this capacitance value (compared with a corresponding background value). Herein, detection on the self-capacitance value may be estimated by measuring time to charge to a voltage level (for example, a TCSV (Time to Charge to Set Voltage) method), or estimated by measuring a voltage value after charging for a particular time (for example, a VACST (Voltage After charging for a Set Time) method). Using the mutual capacitance detection technology as an example, when touch detection is performed, the driving/detection unit selects and drives a first electrode and a second electrode, and then measures a mutual capacitance value between the selected first electrode and second electrode, so as to detect a change in the capacitance value. Herein, when it is measured that the capacitance value is changed to an extent, the control unit 123 may judge that the corresponding sensing point is touched and determine, based on a judgment result, whether a corresponding location signal is returned.

Herein, the capacitive sensing device can actively perform the method for obtaining a safety reference point of a capacitive sensing device according to any embodiment of the present invention, so as to correct the capacitive sensing device on a proper occasion to obtain a proper safety reference point, so that a measurement result of the capacitive sensing device adapts to a measurement environment (such as, current noise state), so as to avoid problems such as reduced accuracy, a decreased recognition rate, and a misjudgment that are caused by a change in the measurement environment.

Referring to FIG. 1 again, the signal processing circuit 12 may further include a signal simulation unit 125 and a storage unit 127. The control unit 123 is coupled to the storage unit 127. The signal simulation unit 125 is electrically connected among the driving unit 121, the detection unit 122 and the control unit 123. The control unit 123 can control operations of each component. Under control of the control unit 123, the capacitive sensing device selectively performs the normal process and the correction process. The storage unit 127 stores a threshold and a difference amount that are needed by the correction process.

In the normal process, an output of the detection unit 122 connects to the control unit 123 and disconnects from the signal simulation unit 125, and the control unit 123 directly performs signal processing on a measured value of the detection unit 122, so as to judge a capacitance value change of each sensing point. Moreover, in the correction process, the detection unit 122 connects to the signal simulation unit 125, so as to perform further signal processing on an output of the signal sensor 14.

Herein, the signal simulation unit 125 is used to generate a touch simulation signal simulating a touch event, and integrate the touch simulation signal and a capacitance value that is obtained by the detection unit 122 from the signal sensor 14. The touch simulation signal is equivalent to a signal strength of occurrence of a touch event. Moreover, the signal simulation unit 125 is further used to generate a touch sensing signal (hereinafter referred to as a first touch sensing signal) simulating that a touch event occurs for the signal sensor 14. Herein, the signal simulation unit 125 may generate a background simulation signal simulating that no touch event occurs for the signal sensor 14. In this case, the signal simulation unit 125 may generate the first touch sensing signal by superimposing the background simulation signal and the touch simulation signal. In an embodiment, operations of the signal simulation unit 125 may be implemented by building gauged software/hardware facilities in the signal processing circuit 12.

The correction process of the capacitive sensing device is further described below in detail.

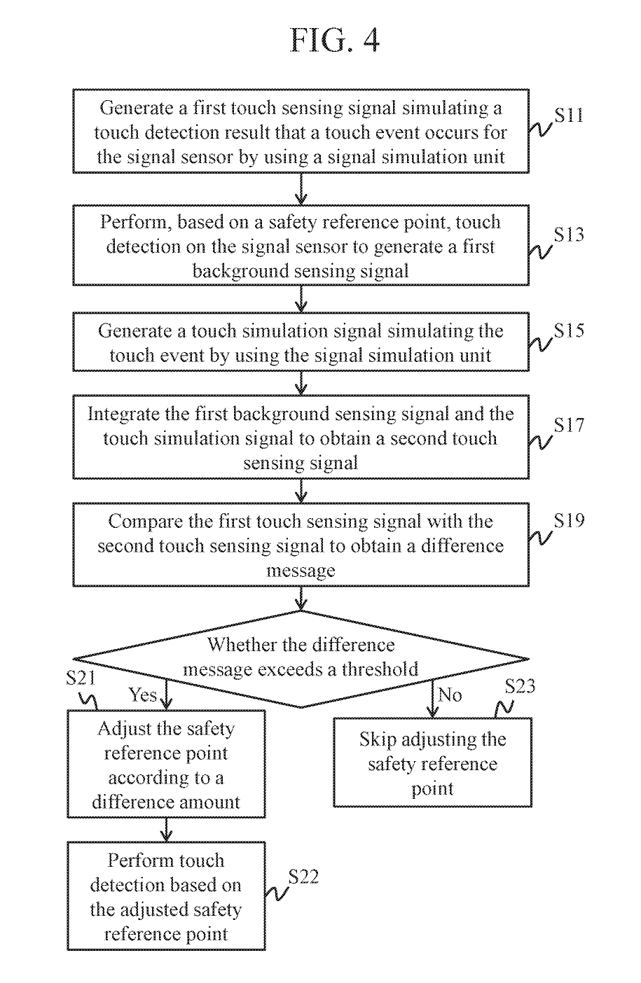

FIG. 4 is a schematic flowchart of a method for obtaining a safety reference point of a capacitive sensing device according to an embodiment of the present invention.

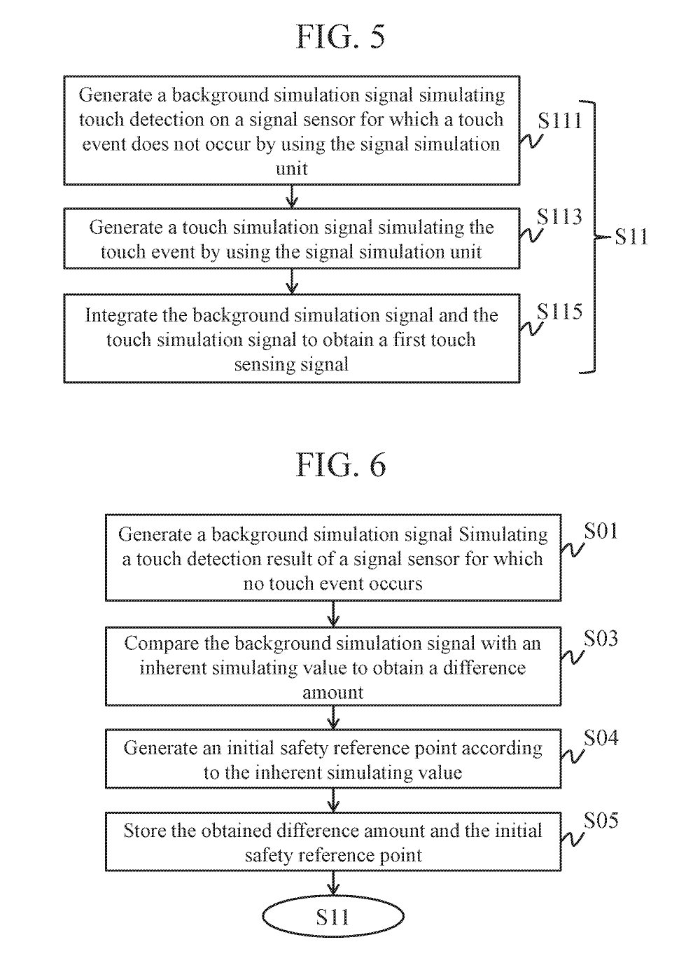

Referring to FIG. 1 and FIG. 4 together, the signal simulation unit 125 generates a first touch sensing signal simulating a touch detection result that a touch event occurs for the signal sensor 14 (step S11). In this case, the signal simulation unit 125 is electrically isolated from the signal sensor 14. In other words, the signal simulation unit 125 independently generates the first touch sensing signal. In some embodiments, referring to FIG. 5 cooperatively, the signal simulation unit 125 simulates touch detection on the signal sensor 14 (for which no touch event occurs) in a clean state to generate a background simulation signal (step S111), and generates a touch simulation signal simulating a touch event (step S113). Then, the signal simulation unit 125 integrates the background simulation signal and the touch simulation signal into the first touch sensing signal (step S115).

Moreover, the signal simulation unit 125 is further connected to the signal sensor 14 to perform measurement, so as to jointly generate another touch sensing signal (hereinafter referred to as a second touch sensing signal). Herein, the driving/detection unit performs touch detection based on the safety reference point by using the signal sensor 14 to generate a background sensing signal. In other words, the driving unit 121 drives the signal sensor 14 and the detection unit 122 measures the signal sensor 14 based on the safety reference point to generate a background sensing signal (step S13). In this case, the signal simulation unit 125 generates a touch simulation signal simulating a touch event (step S15). The signal simulation unit 125 integrates the background sensing signal and the touch simulation signal to obtain the second touch sensing signal (step S17).

After the first touch sensing signal (step S11) and the second touch sensing signal (step S17) are generated, the control unit 123 compares the first touch sensing signal with the second touch sensing signal to obtain a difference message between the two (step S19). Herein, the difference message presents a noise state caused by the current measurement environment to a signal.

Herein, when the difference message exceeds a threshold, the control unit 123 adjusts the safety reference point according to a difference amount (step S21). In this case, in a subsequent normal process, the driving unit 121 drives the signal sensor 14 and performs touch detection based on the adjusted safety reference point by using the signal sensor 14 (step S22). In some embodiments, the control unit 123 may generate a new safety reference point according to the difference amount and the background simulation signal. For example, the control unit 123 may add the difference amount to the measured background simulation signal to obtain the new safety reference point. In the normal process, the control unit 123 enables the driving/detection unit to perform touch detection on the signal sensor 14 based on the adjusted safety reference point (the new safety reference point).

When the difference message does not exceed the threshold, the control unit 123 skips adjusting the safety reference point (step S23).

In an embodiment, the threshold may be an allowable range formed by an upper limit and a lower limit. In this case, if the difference message falls in between the upper limit and the lower limit, it indicates that the difference message does not exceed the threshold; otherwise, if the difference message does not fall in between the upper limit and the lower limit, it indicates that the difference message exceeds the threshold. In another embodiment, the threshold may be a given value. In this case, if the difference message is less than or equal to this given value, it indicates that the difference message does not exceed the threshold; otherwise, if the difference message is greater than this given value, it indicates that the difference message exceeds the threshold.

In some embodiments, the threshold can be determined by using repeated experiments in a clean environment (such as a testing room before delivery) and pre-stored in the storage unit 127.

In some embodiments, the difference amount may be generated by performing the building process in advance during device installation and stored in the storage unit 127, so as to be used by the subsequent correction process.

Referring to FIG. 1, the storage unit 127 may further store an inherent simulating value.

After the device installation (that is, the capacitive sensing device is assembled in an electronic device to which the capacitive sensing device is applied), the control unit 123 first performs the building process, and then performs the normal process or the correction process.

In an embodiment of the building process, referring to FIG. 1, FIG. 2 and FIG. 6 together, after the device installation, the control unit 123 enables the signal simulation unit 125 to simulate a touch detection result of the signal sensor 14 for which no touch event occurs to generate a background simulation signal (step S01). Then, the control unit 123 compares the background simulation signal generated in step S01 with the inherent simulating value to obtain a difference amount between the two (step S03), and stores the obtained difference amount in the storage unit 127 (step S05).

In this case, the control unit 123 further generates the initial safety reference point according to the inherent simulating value (step S04), and stores the initial safety reference point in the storage unit 127 (step S05).

In some embodiments, the inherent simulating value may be determined by using repeated experiments performed by a large quantity of signal processing circuits 12 provided with the signal simulation unit 125 in a clean environment (such as a testing room before delivery) before delivery (before device installation), and be pre-stored in the storage unit 127. For example, the inherent simulating value may be an average value of a large quantity of background simulation signals obtained by performing simulation touch detection by a large quantity of signal processing circuits 12 provided with the signal simulation unit 125 in a testing room before delivery. In other words, the inherent simulating value is a statistical result of a value measured before the signal processing circuit 12 is assembled with the signal sensor 14.

In some embodiments, the signal simulation unit 125 can be implemented by using a software or hardware circuit.

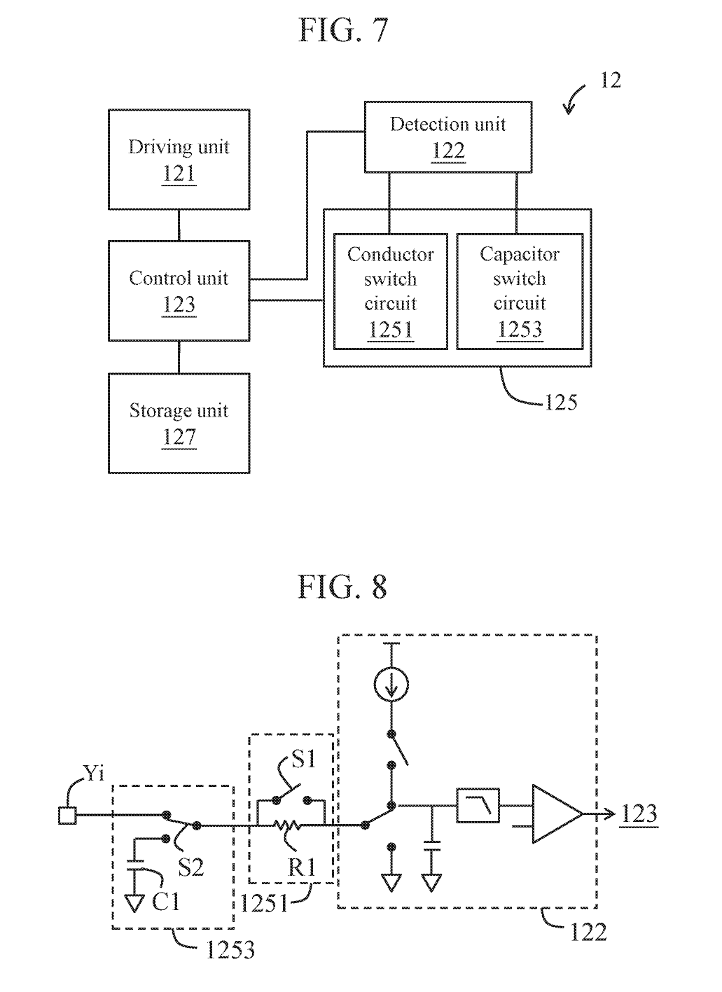

If the signal simulation unit 125 is implemented by using a hardware circuit, referring to FIG. 7, the signal simulation unit 125 may include a conductor switch circuit 1251 and a capacitor switch circuit 1253.

In the normal process, the conductor switch circuit 1251 is not in a signal connection to the detection unit 122, and the capacitor switch circuit 1253 also disconnects from the detection unit 122. In this case, a measurement result of performing touch detection on the signal sensor 14 by the detection unit 122 is directly transferred to the control unit 123, so as to perform subsequent signal analysis and judgment.

In the correction process, when the first touch sensing signal is generated, the detection unit 122 disconnects from the signal sensor 14, and is in a signal connection to the conductor switch circuit 1251 and the capacitor switch circuit 1253. In this case, the conductor switch circuit 1251 and the capacitor switch circuit 1253 jointly operate to generate the first touch sensing signal (step S11).

When the second touch sensing signal is generated, the detection unit 122 disconnects from the capacitor switch circuit 1253, and is in a signal connection to the signal sensor 14 and the conductor switch circuit 1251. In this case, the detection unit 122 performs touch detection on the signal sensor 14 to generate the background sensing signal (step S13). The conductor switch circuit 1251 generates the touch simulation signal (step S15) and integrates the generated touch simulation signal and the background sensing signal into the second touch sensing signal (step S17).

In the building process, the signal sensor 14 and the conductor switch circuit 1251 are not in a signal connection to the detection unit 122, and the capacitor switch circuit 1253 is coupled to the detection unit 122. In this case, the detection unit 122 simulates, by using the capacitor switch circuit 1253, a touch detection result of the signal sensor 14 for which no touch event occurs to generate the background simulation signal (step S01), and provides the touch detection result to the control unit 123.

In an exemplary example, a sensing point P(j,i) defined by a driving electrode Xj and an induction electrode Yi is used as an example. Referring to FIG. 8, the conductor switch circuit 1251 may include one or more combination circuits each having a switch S1 and a resistor R1. The capacitor switch circuit 1253 includes a switch S2 and a capacitor C1 that simulates the signal sensor 14.

Herein, a capacitor switch circuit is used as an example of the detection unit 122, an input of the detection unit 122 is coupled to the induction electrode Yi or the capacitor C1 through the resistor R1 and the switch S2, and the switch S1 is coupled to two ends of the resistor R1. The switch S2 is coupled to the signal sensor 14, the capacitor C1 and one end of the resistor R1, and the other end of the resistor R1 is coupled to the input of the detection unit 122. The driving electrode Xj may be any one of first electrodes X1 to Xn, that is, j may be any one of 1 to n. The induction electrode Yi may be any one of second electrodes Y1 to Ym, that is, i may be any one of 1 to m.

In the normal process, the switch S1 is electrically connected to the two ends of the resistor R1, and the switch S2 connects the signal sensor 14 and the input of the detection unit 122 through the switch S1. In this case, the detection unit 122 directly outputs a measured value of the signal sensor 14 to the control unit 123.

In the correction process, when the first touch sensing signal is generated, the switch S2 connects the capacitor C1 and the resistor R1, and the switch S2 is switched off, so that the capacitor C1, the resistor R1 and the detection unit 122 are in a signal connection. In this case, the detection unit 122 generates a corresponding voltage drop (the touch simulation signal) through the resistor R1 for a measured value (the background simulation signal) of the capacitor C1 to form the first touch sensing signal, and then outputs the first touch sensing signal to the control unit 123. When the second touch sensing signal is generated, the switch S1 is switched off, so that the resistor R1 is in a signal connection to the detection unit 122; and the switch S2 connects the signal sensor 14 and the resistor R1. In this case, the detection unit 122 generates a corresponding voltage drop (the touch simulation signal) through the resistor R1 for a measured value (the background sensing signal) of the signal sensor 14 to form the second touch sensing signal, and then outputs the second touch sensing signal to the control unit 123.

In the building process, the switch Si is switched on, and the switch S2 connects the capacitor C1 and the input of the detection unit 122. In this case, the detection unit 122 directly outputs the measured value (the background simulation signal) of the capacitor C1 to the control unit 123.

In some embodiments, when the conductor switch circuit 1251 has a plurality of combinations of a switch Si and a resistor R1, the switch Si controls a quantity of coupled resistors R1 to provide touch simulation signals corresponding to different capacitance values, that is, different resistance values are touch sensing signals representing touches caused by different touch elements (such as, a finger or water). In some embodiments, when the signal simulation unit 125 has a single combination of a switch Si and a resistor R1, the resistor R1 may be a variable resistor, and the control unit 123 may regulate a resistance value of the variable resistor, so that the resistor R1 provides signal reactions representing touches caused by different touch elements (such as, a finger, water or a foreign matter). In other words, the capacitor switch circuit 1253 has a capacitance value for generating a standard signal strength equivalent to a touch.

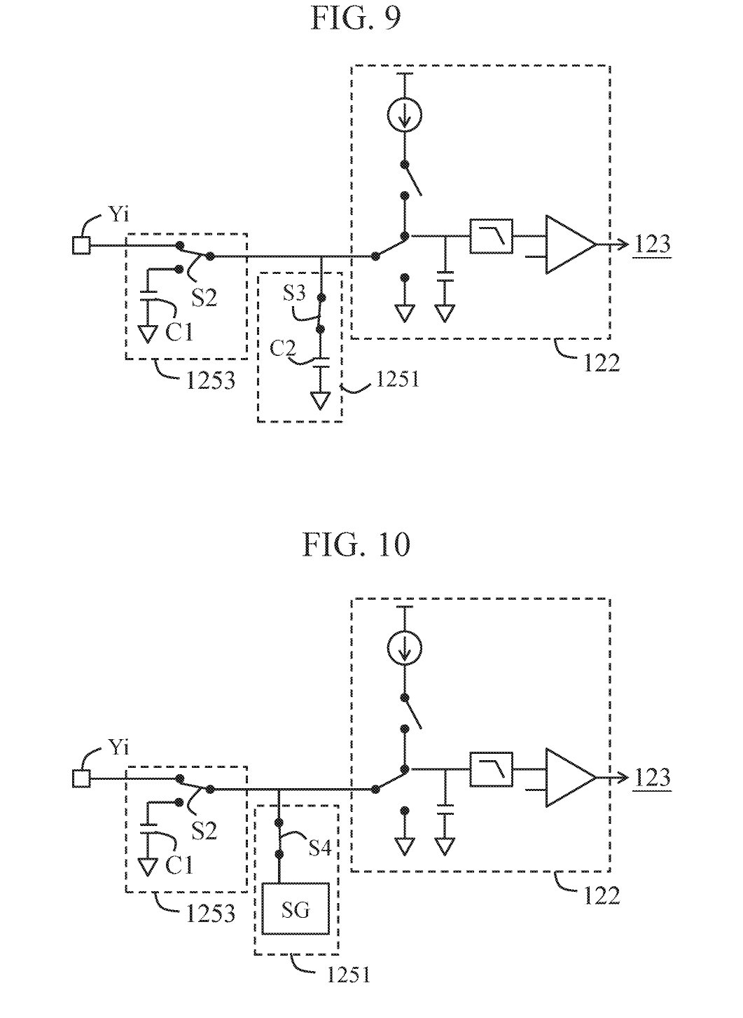

In still another exemplary example, the conductor switch circuit 1251 may be a capacitor switch circuit simulating the signal sensor 14, and may simulate, by switching on or off a parallel-connected capacitor in the capacitor switch circuit, occurrence of a touch or occurrence of no touch. For example, a sensing point P(j,i) defined by a driving electrode Xj and an induction electrode Yi is used as an example. Referring to FIG. 9, the conductor switch circuit 1251 may include one or more combination circuits of a switch S3 and a capacitor C2. The capacitor switch circuit 1253 includes a switch S2 and a capacitor C1 that simulates the signal sensor 14.

Herein, a capacitor switch circuit is used as an example of the detection unit 122, an input of the detection unit 122 is coupled to the induction electrode Yi or the capacitor C1 through the switch S2, and the capacitor C2 is coupled to the input of the detection unit 122 through the corresponding switch S3. The driving electrode Xj may be any one of first electrodes X1 to Xn, that is, j may be any one of 1 to n. The induction electrode Yi may be any one of second electrodes Y1 to Ym, that is, i may be any one of 1 to m.

In the normal process, the switch S2 connects the signal sensor 14 and the input of the detection unit 122, and the switch S3 is switched off. In this case, the detection unit 122 directly measures a capacitance value of an induction capacitor of the induction electrode Yi, and outputs the capacitance value to the control unit 123.

In the correction process, when the first touch sensing signal is generated, the switch S2 connects the capacitor C1 and the input of the detection unit 122, and the switch S3 connects the capacitor C2 and the input of the detection unit 122, so that the capacitor C2 and the capacitor C1 are connected in parallel. In this case, after measuring a total sum (the first touch sensing signal) of the capacitance value (the background simulation signal) of the capacitor C1 and the capacitance value (the touch simulation signal) of the capacitor C2, the detection unit 122 outputs the total sum to the control unit 123. When the second touch sensing signal is generated, the switch S2 connects the signal sensor 14 and the input of the detection unit 122, and the switch S3 connects the capacitor C2 and the input of the detection unit 122, so that the capacitor C2 and the induction capacitor of the induction electrode Yi are connected in parallel. In this case, after measuring a total sum (the second touch sensing signal) of the capacitance value (the background sensing signal) of the induction capacitor of the induction electrode Yi and the capacitance value (the touch simulation signal) of the capacitor C2, the detection unit 122 outputs the total sum to the control unit 123.

In the building process, the switch S3 is switched off, and the switch S2 connects the capacitor C1 and the input of the detection unit 122. In this case, the detection unit 122 directly outputs the measured value (the background simulation signal) of the capacitor C1 to the control unit 123.

In some embodiments, when the conductor switch circuit 1251 has a plurality of combinations of a switch S3 and a capacitor C2, the switch S2 controls a quantity of parallel-connected capacitors C1 to provide touch simulation signals corresponding to different capacitance values, that is, different capacitance values are touch sensing signals representing touches caused by different touch elements (such as, a finger or water). In some embodiments, when the signal simulation unit 125 has a single combination of a switch S2 and a capacitor C1, the capacitor C1 may be a variable capacitor, and the control unit 123 may regulate a capacitance value of the variable capacitor, so that the capacitor C1 provides signal reactions representing touches caused by different touch elements (such as, a finger, water or a foreign matter).

In another exemplary example, a sensing point P(j,i) defined by a driving electrode Xj and an induction electrode Yi is used as an example. Referring to FIG. 10, the conductor switch circuit 1251 may include a switch S4 and a signal generator SG. Moreover, the signal generator SG is coupled to an input of the detection unit 122 through the switch S4. The capacitor switch circuit 1253 includes a switch S2 and a capacitor C1 that simulates the signal sensor 14. The switch S2 is coupled to the input of the detection unit 122, the induction electrode Yi and the capacitor C1. Herein, a capacitor switch circuit is used as an example of the detection unit 122, and the input of the detection unit 122 is coupled to the induction electrode Yi or the capacitor C1 through the switch S2. The driving electrode Xj may be any one of first electrodes X1 to Xn, that is, j may be any one of 1 to n. The induction electrode Yi may be any one of second electrodes Y1 to Ym, that is, i may be any one of 1 to m.

In the normal process, the switch S2 connects the signal sensor 14 and the input of the detection unit 122, and the switch S4 is switched off. In this case, the detection unit 122 directly measures a capacitance value of an induction capacitor of the induction electrode Yi, and outputs the capacitance value to the control unit 123.

In the correction process, when the first touch sensing signal is generated, the switch S2 connects the capacitor C1 and the input of the detection unit 122, and the switch S4 is switched on. In this case, the signal generator SG may generate a touch simulation signal in a software form, and the capacitance value (the background simulation signal) of the capacitor C1 measured by the detection unit 122 and the touch simulation signal generated by the signal generator SG are integrated into the first touch sensing signal. When the second touch sensing signal is generated, the switch S2 connects the signal sensor 14 and the input of the detection unit 122, and the switch S4 is switched on. In this case, the signal generator SG may generate a touch simulation signal in a software form, and the capacitance value (the background sensing signal) of the induction capacitor of the induction electrode Yi measured by the detection unit 122 and the touch simulation signal generated by the signal generator SG are integrated into the second touch sensing signal.

In the building process, the switch S4 is switched off, and the switch S2 connects the capacitor C1 and the input of the detection unit 122. In this case, the detection unit 122 directly outputs the measured value (the background simulation signal) of the capacitor C1 to the control unit 123.

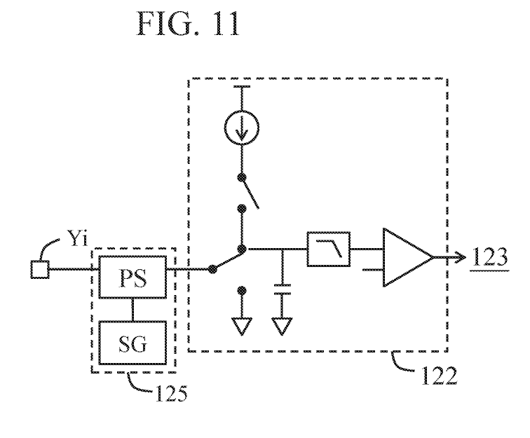

In some embodiments, the signal generator SG can generate a plurality of simulation signals, that is, the touch simulation signal simulating the touch event, the background simulation signal simulating a touch detection result that no touch event occurs for the signal sensor 14, and the first touch sensing signal simulating a touch detection result that a touch event occurs for the signal sensor 14. A sensing point P(j,i) defined by a driving electrode Xj and an induction electrode Yi is used as an example. Referring to FIG. 11, the signal simulation unit 125 may include a signal generator SG and a path selection unit PS.

In the normal process, the control unit 123 disables the signal generator SG, and the path selection unit PS connects the input of the detection unit 122 and the signal sensor 14. In this case, the detection unit 122 directly measures a capacitance value of an induction capacitor of the induction electrode Yi, and outputs the capacitance value to the control unit 123. In the correction process, when the first touch sensing signal is generated, the path selection unit PS disconnects the input of the detection unit 122 from and the signal sensor 14 and connects the signal generator SG and the input of the detection unit 122. In this case, the control unit 123 enables the signal generator SG to output the first touch sensing signal to the control unit 123. When the second touch sensing signal is generated, the path selection unit PS connects the signal sensor 14, the signal generator SG and the input of the detection unit 122. In this case, the detection unit 122 measures the induction capacitor of the induction electrode Yi to generate the background sensing signal, the control unit 123 enables the signal generator SG to output the touch simulation signal, the background sensing signal and the touch simulation signal are integrated into the second touch sensing signal, and then the second touch sensing signal is output to the control unit 123. In the building process, the path selection unit PS disconnects the input of the detection unit 122 from and the signal sensor 14 and connects the signal generator SG and the input of the detection unit 122. In this case, the control unit 123 enables the signal generator SG to output the background simulation signal to the control unit 123.

In an embodiment, the signal simulation unit 125 and the signal sensor 14 can generate a corresponding signal under a same group of signal parameters. In another embodiment, the signal simulation unit 125 and the signal sensor 14 can also generate a corresponding signal under different groups of signal parameters, but types of the signal parameters (for example, a frequency of the driving signal, an amplitude of the driving signal, a waveform of the driving signal, a gain of the driving signal, a voltage of the driving signal or any combination thereof) are the same.

In some embodiments, the signal simulation unit 125 is built in a chip of a capacitive sensing device and is isolated from an external environment of the capacitive sensing device. In other words, for a signal sensor 14, the signal simulation unit 125 is encapsulated internally and cannot be contacted or approached (sufficiently affecting an electrical property thereof) by a finger, and therefore is not easily subjected to interference of an external noise. The chip of the built signal simulation unit 125 may be an independent chip that does not implement other elements (a control unit, a driving/detection unit and a path selection unit), or be a multi-functional chip that implements the signal simulation unit 125 and other elements (a control unit, a driving/detection unit, a path selection unit or any combination thereof). In other words, the signal processing circuit 12 may be implemented by one or more chips. In some other embodiments, the signal simulation unit 125 may be built-in on a circuit board of the capacitive sensing device, but isolated from an external environment of the capacitive sensing device.

In some embodiments, the storage unit 127 is used to store a related software/firmware program, data, data and a combination thereof. Herein, the storage unit 127 may be implemented by one or more memories.

To sum up, in the capacitive sensing device and the method for obtaining a safety reference point of the same according to the present invention, a signal simulation unit (software or hardware) is used to directly simulate a sensing signal, and then whether a measurement condition (for example, safety reference point) is proper is judged according to the simulated sensing signal and an actually measured sensing signal, so as to appropriately perform corresponding adjustment, and then improve accuracy and/or a recognition rate of the capacitive sensing device.

What is claimed is:

1. A method for obtaining a safety reference point of a capacitive sensing device, comprising:
simulating, by a signal simulation unit, a touch detection result that a touch event occurs to generate a first touch sensing signal;
performing, based on a safety reference point, touch detection on a signal sensor to generate a background sensing signal;
simulating, by the signal simulation unit, the touch event to generate a touch simulation signal;
integrating the background sensing signal and the touch simulation signal to obtain a second touch sensing signal;
comparing the first touch sensing signal with the second touch sensing signal to obtain a difference message;
adjusting the safety reference point according to a difference amount when the difference message exceeds a threshold; and
skipping adjusting the safety reference point when the difference message does not exceed the threshold.

2. The method for obtaining a safety reference point of a capacitive sensing device according to claim 1, wherein the signal simulation unit comprises: a conductor switch circuit and a capacitor switch circuit, the conductor switch circuit has a capacitance value for generating a standard signal strength equivalent to a touch, and the capacitor switch circuit is a simulation circuit of the signal sensor.

3. The method for obtaining a safety reference point of a capacitive sensing device according to claim 1, wherein a step of simulating, by the signal simulation unit, a touch detection result that a touch event occurs to generate the first touch sensing signal comprises:
simulating, by the signal simulation unit, a touch detection result that a touch event does occur to generate a background simulation signal;
simulating, by the signal simulation unit, the touch event to generate the touch simulation signal; and
integrating the background simulation signal and the touch simulation signal to obtain the first touch sensing signal.

4. The method for obtaining a safety reference point of a capacitive sensing device according to claim 3, wherein a step of adjusting the safety reference point according to the difference amount comprises:
generating a new safety reference point according to the difference amount and the background simulation signal.

5. The method for obtaining a safety reference point of a capacitive sensing device according to claim 1, further comprising:
simulating, after device installation, the touch detection result that a touch event occurs to generate a background simulation signal;
comparing the background simulation signal with an inherent simulating value to obtain the difference amount; and
storing the obtained difference amount.

6. The method for obtaining a safety reference point of a capacitive sensing device according to claim 5, wherein the inherent simulating value is built in before delivery, and the initial safety reference point is generated according to the inherent simulating value.

7. A capacitive sensing device, comprising:
a signal sensor, comprising: a plurality of first electrodes and a plurality of second electrodes that are disposed in a staggered manner; and
a signal processing circuit, electrically connected to the signal sensor, wherein the signal processing circuit performs:
generating a first touch sensing signal simulating a touch detection result that a touch event occurs for the signal sensor;
performing, based on a safety reference point, touch detection on the signal sensor to generate a background sensing signal;
generating a touch simulation signal simulating the touch event;
integrating the background sensing signal and the touch simulation signal to obtain a second touch sensing signal;
comparing the first touch sensing signal with the second touch sensing signal to obtain a difference message;
adjusting the safety reference point according to a difference amount when the difference message exceeds a threshold, so as to drive the signal sensor to perform touch detection based on the adjusted safety reference point; and
skipping adjusting the safety reference point when the difference message does not exceed the threshold.
